(19) United States
(12) Patent Application Publication
(10) Pub. No.: US 2005/0161507 A1
(43) Pub. Date: Jul. 28, 2005

(54) Voting method and apparatus

(76) Inventors: Mark Openshaw II, Provo, UT (US); Guy David Payne, Castle Rock, CO (US); John Robert Walz, Provo, UT (US)

Correspondence Address: MARCUS G THEODORE, PC, 466 SOUTH 500 EAST, SALT LAKE CITY, UT, 84102, US

(21) Appl. No.: 11/086,845

(22) Filed: Mar. 22, 2005

Related U.S. Application Data
(63) Continuation-in-part of application No. 09/764,969, filed on Jan. 18, 2001, now abandoned.

(51) Int. Cl. G06F 17/60

(52) U.S. Cl. 235/386

(57) ABSTRACT

The present specification discloses a secure, inexpensive, highly accurate and convenient mobile voter precinct tabulating computer terminal operably associated with touchtone telephones on a virtual private network, which employs audio ballot questionnaire software to solicit and record voter preferences, generates dual voter receipts listing each voter's choices for manual audits and recounts, and then transmits voter tabulations to a remote central processing terminal for final certification.

### RELATED APPLICATIONS

This application is a continuation-in-part application of the original patent application entitled “Voting Method and Apparatus” filed Jan. 18, 2001, Ser. No. 09/764,969.

### BACKGROUND OF THE INVENTION

1. Field of Invention

The present invention relates to voting terminals and a method of using the same. In particular, it relates to a highly accurate inexpensive easy to use voting terminal employing telephones attached to a secure line interacting with an isolated voice responsive election computer adapted for tabulating votes for use with various types of elections.

2. Description of Related Art

Various voting terminals and voting systems are known. Willard, U.S. Pat. No. 5,821,508 describes an audio ballot system for voters who are blind, illiterate, or conversant in a foreign language employing complicated speech input and communication devices. Gordon et al., U.S. Pat. No. 3,766,541 describes a voting machine employing a series of parallel DC circuits with a switch for each voter to vary the intensity of the input to determine the voter confidence in each vote. De Phillipo, U.S. Pat. No. 4,015,106 described an electronic voting machine employing a circuit recording switch signals on an integrated keyboard. Anno et al, U.S. Pat. No. 5,189,288 describes a method and system for automated voting employing key cards issued to record and count ballot choices. Harp, Jr., U.S. Pat. No. 5,585,612 describes a method and apparatus for enabling the sight impaired to vote using an audio player system in a booth with a control panel. Wang et al., U.S. Pat. No. 5,638,486 describes a continuous speech recognition system to record sign impaired voters choices. Pykalisto, U.S. Pat. No. 5,970,385 discloses a televoting system in an intelligent network primarily used for conducting marketing surveys via public telephone networks.

There are some 190,000 voting precincts in the United States with a baffling array of voting booths, ballots and procedures. One in five precincts still use mechanical levers, a technology unchanged in the last 100 years. Most precincts use some variation of the “punch card” system like those used in the 2000 election in Palm Beach, Fla. Engineering Professor William Rouverol developed the most popular voting machine known as “Votomatic” in 1962. At the time the system used the most up to date technology available. But by today's standards using the Votomatic punch cards for an election is akin to watching black and white television or listening to 45 records. It is estimated that one or two percent of voters using the current system spoil their own ballots—as many as 20 percent in more confusing races. More reliable and efficient technology is available, but state and local governments have been reluctant to invest because of cost. A small number of precincts have invested in electronic voting screens where selections light up and changes can be made until the voter makes them final. Larry Ensminger of Global Elections calls it the wave of the future:
“You'll be able to go to a mall or to a transportation center or generally where people congregate and cast your ballot via a touch screen on a kiosk much in the same manner as the way ATMs took the banking process to the public.”

Another company, elections.com, claims the public can “Vote from home in their pajamas over the Internet.”

While these systems are advanced and state of the art, they are not the answer to America's voting dilemma. Many people in this country don't have Internet connection. Many don't have a home with a telephone, nor are these public access lines secure to prevent tampering. Our nation cannot rush into technology that would preclude any citizen from being able to cast a vote. These systems are also expensive, because of the security and specialized equipment required to safeguard the votes. The invention described below, provides a speedy, accurate, and secure and cost effective voting system and method, which incorporates voting receipts for auditing checks.

### Advantages of the Invention

The present invention provides a vote tabulation and collection system to improve the reliability, speed and accuracy of the voting process, making sure every vote is properly counted while giving all eligible voters equal access. It does not rely on a global communication system, and therefore provides a secure voting environment, which does not require encoding and decoding of the data. Nor does the present invention replace the current voting system. It improves the current voting system's accuracy and security. Specifically, the invention:
1) Allows election officials to cross check information with multiple outside agencies to verify the eligibility of the registrant.
2) Uses private data lines to ensure security and prevent outside interference.
3) Separately stores the registration database, voter access database and completed ballot database to insure that the content of the ballot cannot be traced back to the individual voter.
4) Copies and forwards completed ballot information to regional locations and to the central location for final certification.
5) Provides a unique electronic ballot that contains all the various options for each precinct.
6) Tabulates all the votes and makes the count available within seconds after the polls close.
7) Creates election information reports on various topics such as: Number of registered voters who actually voted, People who tried to vote with an improper registration or voter access number, and Peak times at election precincts.
   The invention enhances the advantages of the present voting system and method by providing easy to use touchtone telephone voting input devices to expedite recording of votes and insures better monitoring of the voting process with appropriate voter feedback to insure that each vote was intended. It is also economical and relatively cost effective to implement.

### SUMMARY OF THE INVENTION

The invention allows voters to register as required by state law. Each voter is assigned a registration identification number that groups him or her with their state, county and voting precinct. On Election Day the voter goes to their assigned polling place as they do now. They show identification to the election judge, sign in to verify their identity and are given a paper with their permanent registration number (RN) and an election specific voter access number (VAN). In another voter qualification scenario, voice identification software associated with a computer and input microphone may be used to record and compare a voter's voice print with a master index to expedite this voter qualification process.

The voters then go into a voting booth or voting station utilizing telephones attached to a secure line feeding into an isolated election computer. Instead of using a paper ballot, the voter enters the voter access information into a voice automated telephone system that then talks them through the voting process. For the hard of hearing, sound amplified TDD telephones may be used. Similarly, a Braille telephone system may be employed for those who are blind and hard of hearing.

This automated telephone system first asks the votes to enter their registration number, and then their voter access number. The computer scans the combination of the RN and VAN numbers and, if correct, opens an Election Direct Program, which is inputted into the computer. (The voice activated system, compares the voice print with the stored voice print before activating the Election Direct Program). The Election Direct Program then assigns the voter a pre-approved random electronic ballot, which is read by the computer. The voter selections are randomized to avoid the need of a secure voting booth as observers would not be able to detect the voters' preferences by observing the touchtone selections. This allows more voter telephone stations to be added by an election judge to handle problems when large crowds of voters show up simultaneously and additional isolated voting booths cannot be installed.

The computer automated voice is then transmitted through the phone speaker to identify the candidates unique to that precinct in each category in a rotating random order. For example, using the national candidates for the last election, the computer automated voice would state:
“For the Office of President of the United States; press the number one on the telephone dial if you want to vote for Democratic candidate Al Gore. Press number two if you want to vote for Republican candidate George Bush. Press number three if you want to vote for Green Party candidate Ralph Nadar. Press number 4 if you want to vote for Independent candidate Pat Buchanan.”
   After the voter selects and presses their voter selection, the computer asks the voter to verify the selection. For example, a voter voting for Ralph Nader for the Office of the President, would be asked:
“You have selected candidate number 3, Ralph Nader, for the office of President of the United States. If that selection is correct, press the number 9. If you would like to start over on this category press the number 7.”
   After number 7 is pressed, the computer in the above example would state:
“You have selected Ralph Nadir for the office of President of the United States.”

The Election Direct system talks the voter through all the options on the ballot approved for their precinct. At the end they would hear a menu of the selections they made and are given a second chance to make changes before submitting the final ballot.

Two written receipts listing voter choices are then printed—the voter would get a copy of one and the other would be deposited directly into a locked drop box to be made available for a physical recount, if necessary. The exact receipt format conforms to local voting requirements.

The Election Direct system is a PC based system that runs on dialogic cards. It performs the following steps:
Step #1. Registering voters in accordance with local, state and federal election laws, usually in the following sequence:
A. The voter is assigned a registration number.
B. The name and the number are stored together electronically in the database.
C. A cross check of the data base is done to find any duplicates in the system, incorrect information, change of address or name. (It could be possible to cross check the data base with other governmental agencies to find those not eligible to vote.)
D. Registered voters are sent an information post card with a toll free number. They can call to check their voter information and obtain information about up coming elections.
Step #2. Creating the ballot, generally as follows:
A. Election officials develop the content of each specific ballot to be used in the election.
B. Election officials voice the content of each ballot and other election materials, or forward a copy of the ballot to Election Direct for production.
C. Election officials review the audio ballot over the telephone and make the test vote available to voters.
Step #3. Voting utilizing a personal computer with between 4 and 12 ports is set up in each voter precinct. Standard telephone lines run from the PC to telephones located inside each voting booth. The voter is then allowed to vote after completing the following procedures:
A. Election judges verify the identity of voting applicants by drivers license photo or other acceptable identification. The voter signs their name in the election book.
B. The voter is then given a slip of paper that has the registration number and the voter access number and goes into the voting booth.
C. Once the proper registration number and proper access number are entered into the system via the telephone touch pad the voter is accepted into the Election Direct system.
D. A random electronic ballot is assigned. It contains a number identifying the: state, location of the precinct and an anonymous ballot identification number. (i.e.: 39UT100324)
E. The automated telephone system talks the voter through the ballot and lets them make changes and then a final review before they submit the ballot.
Step #4. Collecting the ballots as follows:
A. The final ballot selection made by the voter is transmitted via touch-tone to the PC located in the precinct where it is stored and then forwarded via a secure data line to the county election office.
B. The ballot information from the voter precincts is copied and stored a second time and is continuously forwarded to the Lt. Governor's office via a secure data line.
C. The information from each county election office is copied, stored and printed for use by the Lt. Governor's office to certify the election results.
D. Election officials are given an electronic database of those who voted and those who did not and any other information generated by the Election Direct System.

To insure security of the voting process, all information transmitted within the Election Direct System is on a Virtual Private Network (VPN) in communication with a precinct tabulating personal computer employing the Election Direct System data entry software. This eliminates any opportunity for external hackers or crackers to enter the system. Only the combination of an approved registration number (Social Security Number) and a valid unique voter access number (VAN) will engage the Election Direct System. Codes on each electronic ballot identify the location of the precinct and the county, but are never connected to the registration or voter access number. This allows election officials to know who voted in an election, but prevents anyone from knowing how someone voted. It allows the anonymous results to be accurately counted and properly stored.

Although other voice activated voter input systems may be employed, a conventional touchtone telephone is preferred for instructing and requesting a voter to enter their preferences, because of its familiarity with most voters. This eliminates the need for extensive usage instruction, while maintaining high voter accuracy. Touchtone telephones are also inexpensive, and can be employed with or without a booth to enter voter preferences as the key entry of votes is random and cannot be detected without overhearing the voter instructions. These telephones can also employ sound amplifiers for the hearing impaired.

For those who cannot hear the instructions or those who cannot press the telephone buttons, the system may be by-passed and a standby paper ballot may be employed, or an election judge used to assist the voter in casting their ballot. These standby votes are then inputted into the precinct voter personal computer by the election judge to add into the voter totals.

The precinct voter personal computer preferably employs on-line real time software to instantaneously check all votes for accuracy, and maintain running vote totals. If permitted by local law, precinct voter personal computer may also employ on-line real time software compatible with the state or voting district central processing receiving terminal wherein all votes are monitored and stored. The central processing receiving terminal checks all votes for accuracy and maintains master records of all transactions, and is in communication with one or more precinct voter personal computer terminals (“VPC”) of this invention. They are connected by an independent wire or optical fiber link with each authorized telephone to securely record and transmit voter transactions.

The voter telephones have compatible software with the VPC central processing and receiving terminal, and includes additional interface monitoring software, which monitors the telephone equipment performance. The preferred software not only controls and monitors the peripheral telephone equipment, but signals AC power failure, low battery condition, or when system shutdown time has arrived. It also provides a log file for recording all power events such as power failures, low battery condition, and shutdown times.

The remote voter precinct personal computer VPC terminals are mobile and can be quickly set up in various precinct locations to collect, process, and review the signals sent by the telephone transmitters and generate appropriate response signals. The VPC central processing terminals collect the electronic response signals to translate the response voter signals, and generate an appropriate activation response to record the votes.

To power the system components, a conventional 120 Volt AC power source is used. A backup portable electric power source, such as a rechargeable battery system, may be included to activate the VPC terminals, and telephone transmitters and receivers. A preferred rechargeable sealed lead dioxide system 12 volt battery is that produced by Power Sonic Corporation, Model PS-12600.

In addition to the rechargeable battery system, the VPC central processing terminals are preferably equipped with a separate uninterruptible power source to insure that data is not lost. A preferred back up system is that produced by TSI Power Corporation under its UPS 400B/600B uninterruptible power supplies. They have 8 hour recharge capacity, 400VA and 600 VA output, operate at universal 50/60 Hz frequency, and are network and UNIX compatible. They are also rechargeable with 95 to 135 VRMS, 47-63 Hz sinusoidal AC input.

The mobile VPC central processing terminals thus provide a convenient voting terminal for voters. They are connected to a centralized state or district receiving computer to verify the validity of the voting transactions. Thus, fraudulent votes are minimized. They also allow local election judges to identify voters having trouble voting and to timely intercede to insure that the voter has properly voted.

Mobile VPC terminals allow election judges to maintain better supervision of the voting process. They may add additional voting telephone stations, where needed to provide great flexibility to deal with larger voter turnouts, or remove the same to prevent tampering. They are moved around and added within the voter precinct to accommodate voters' needs.

The present invention thus provides a secure, inexpensive, highly accurate and convenient mobile VPC central processing terminal and voting system, which is readily adapted to provide for a voters' needs to participate in the election process. It incorporates a voter receipt tracking standby system for voter audits and is readily adapted for use with different languages. It can also be adapted to take various product marketing surveys, trademark and brand name comparison surveys, etc., when not in use for official and unofficial elections.

### BRIEF DESRIPTION OF THE DRAWINGS

FIG. 1 is a flow chart of the applicant's method of voting.

FIG. 2 is a system schematic diagram showing the interconnection of the various components.

FIG. 3 is a flow chart of a preferred method of voting.

FIG. 4 is a system schematic diagram showing the interconnection of the various components employed with the preferred method of voting shown in FIG. 3.

### DESCRIPTION OF THE ILLUSTRATED EMBODIMENTS

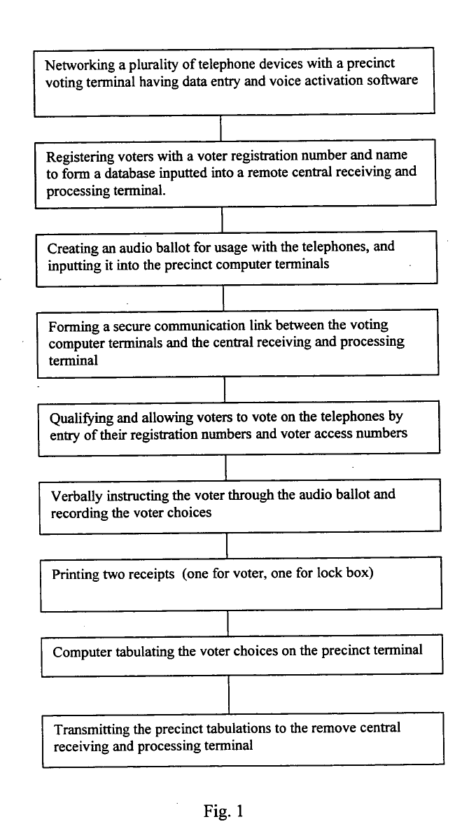

FIG. 1 is a flow chart of applicant's preferred method of voting. The voting method employs interconnected precinct voting terminals having data entry and voice activation software with a plurality of automated touchtone telephone devices. These touchtone telephones have microphones, receivers, transmitters and receivers, and entry keypads. They are interconnected with the precinct voting terminals via a virtual private network. Voters are then registered in accordance with election laws and assigned a voter registration number. Their names and voter registration numbers are then inputted into a database stored in a remote central receiving and processing terminal.

Next, an audio ballot is created suitable for transmission over a telephone, and is inputted into a database including audio ballot instructions required in each respective precinct computer terminal. A secure communication link between the precinct voting computer terminal and the central receiving and processing terminal is formed to transmit voting transaction election results.

To vote, a voter access number is assigned to each voter to use with his/her voter registration number. Voters then input their registration number and voter access number into the voter touchtone telephones, which are checked by the precinct computer. If the numbers correspond, the precinct computer then transmits instructions to the telephone receivers and speakers to talk the voter through the ballot. The voter then records their preferences on the telephone keypad or audio responds by talking into the microphone and the signals are transmitted to the precinct computer voting terminal. After voting, two receipts listing voter choices, one for the voter, and one for deposit in a lockbox are generated to provide a paper trail for follow-up audits and recounts. The precinct computer then tabulates the voter's choices, and transmits the tabulated results to the remote central receiving and processing terminal for certification.

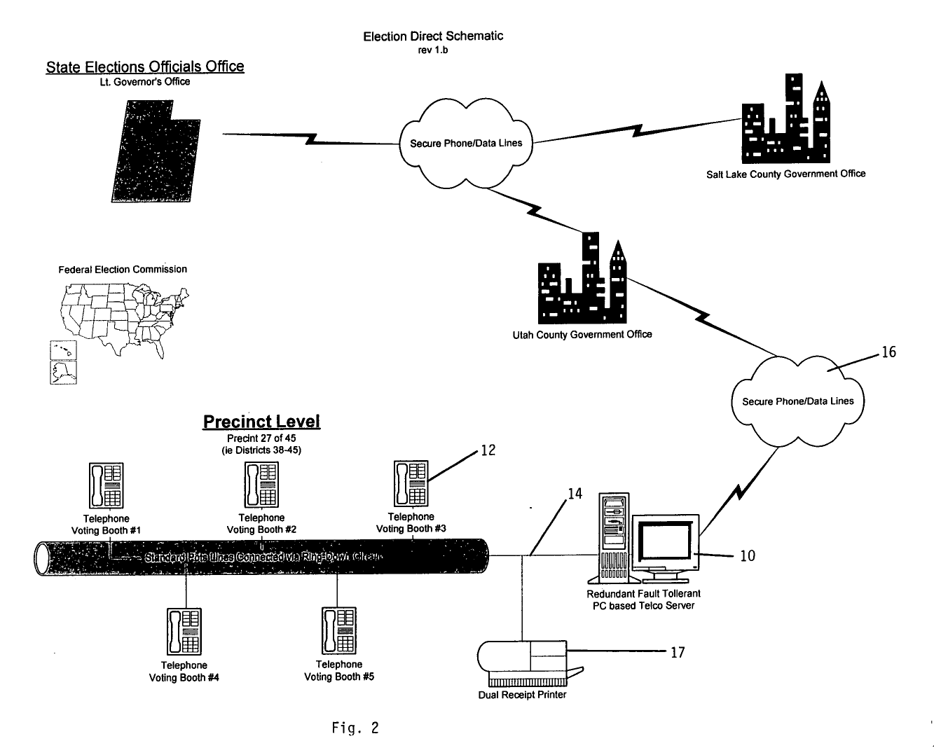

FIG. 2 is a system schematic diagram showing the interconnection of the various components. At least one precinct voting computer terminal 10 such as a Dell xxx fault tolerant server with dual power supplies and mirrored hard drives, having data entry and voice activation software associated with voice board(s) like Dialogic D/41-ESC or D240SC-T-1. A plurality of automated touchtone telephones 12 having microphones, receivers, transmitters and receivers, and entry keypads with compatible voter software are connected to the precinct voting computer terminal 10 via a virtual private network 14.

A remote central receiving and processing terminal (not shown) is in communication with the precinct voting terminals via a secure phone/data lines 16.

Election voting software is inputted into the remote central receiving and processing terminal, which screens registering voters in accordance with election laws, and generates voter registration numbers, voter access numbers, and name lists.

A database containing registration number and name list information on each voter in each respective precinct is then inputted into the remote receiving and processing terminal.

Voter tabulation software is then inputted into the precinct voting terminals 10 for counting voter audio choices. A database containing approved audio ballot and instructions is then inputted into each respective precinct voting computer terminal 10. These precinct voting computer terminals 10 then transmit the voting instructions to the touchtone telephones 12 to elicit voter choices. The number of telephones 12 is selected to meet the voter needs in each precinct and may be changed depending upon voter turnout.

The precinct voting computer terminals 10 generate a database tabulation of voter choices generated by the voter tabulation software made after each voter enters their registration number and voter access number.

A secure communication link 16 between the precinct voting computer terminal and the central receiving and processing terminal transmits the tabulated voter choices for certification by the appropriate county, state, or federal agency. The entire voting system has a power source (not shown) associated with the virtual private network to power the computer terminals, telephone devices, and related equipment to transmit the voting results in a secure and inexpensive manner.

To insure an audit trail, a dual receipt printer 17 prints two receipts one for the voter and one to be deposited in a lock box, not shown.

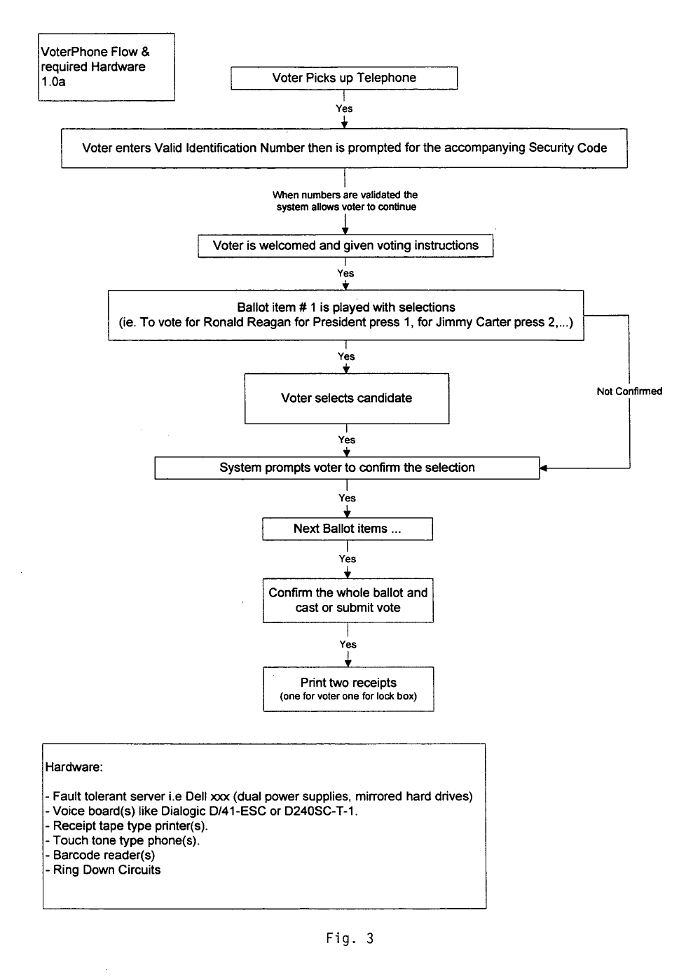

FIG. 3 is a flow chart of a preferred method of voting using the invention 10 employing touchtone telephones 12, a fault tolerant PC based server 10 with dual power supplies, mirrored hard drives, and voice boards, optional barcode readers, and ring down circuits. First the voter picks up the telephone 12. The voter then enters his identification number and is prompted to enter the accompanying security code. The computer 10 then validates the numbers and allows the voter to continue on the touchtone telephones 12. A welcome message is then generated and transmitted through the telephone 12 amplifier, along with voting instructions. The first ballot item is then transmitted along with a list of the candidates for office. The voter then selects a candidate by entering the appropriate touchtone key for the candidate selected. The computer 10 then prompts the voter to confirm the selection by re-entering on the touchtone keyboard the selection made. If the selection is confirmed by the computer 10, the next ballot item is transmitted through the telephone 12 amplifier, along with the list of candidates for this office. The voter then enters on the touchtone keyboard his preferences and the process is repeated until the end of the audio ballot is completed and recorded into the PC based server 10. After the voter votes, a dual receipt printer 17 prints two receipts one for the voter and one to be deposited in a lock box. The tabulated results are then transmitted to the remote central receiving terminals.

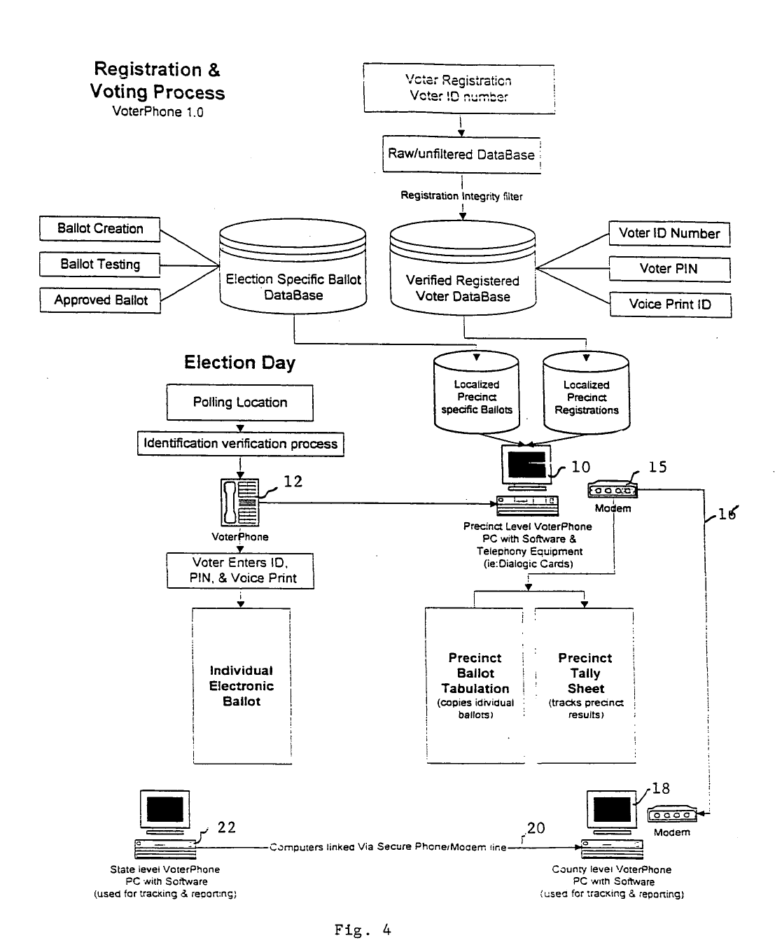

FIG. 4 is a system schematic diagram showing the interconnection of the various components employed with the preferred method of voting shown in FIG. 3. First a data base of voter registration and voter identification numbers is entered and verified into the precinct computer terminals 10. Next an election specific ballot data base is generated from a voice ballot, which is tested and approved and then entered into the precinct computer terminals. The precinct computer terminals 10 then filter, and assign voter identification numbers, voter pin numbers, or voice print identification numbers for each voter entitled to vote in the precinct. The approved voice ballots, ballot instructions, voter qualification and identification numbers are then transmitted by the precinct computer 10 through the touchtone telephones 12. After the voters vote as described above on the touchtone telephones 12, the precinct computer 10 the tabulates the ballots, and generates voter tally sheets, which are transmitted via a modem 15 on a secure line 16 to a county level VoterPhone PC 18 with software used for tracking and reporting the voter results. The County level computer 18 is linked via a secure Phone/Modem line 20 to a State level VoterPhone PC 22 with corresponding software used for tracking and reporting the voter results.

Accordingly, the electronic voting system employing mobile voting precinct terminals and touchtone telephones of the present invention may be used easily and efficiently adapted to provide different for different types of voting. Additional advantages may be realized by reference to the previous specification and the ensuing claims.

The above description and specification should not be construed as limiting the scope of the invention but as merely providing illustrations of some of the presently preferred embodiments of this invention. The scope of the invention should be determined by the appended claims and their legal equivalents rather than by the examples given.

1. A voting method comprising:
a. interconnecting at least one precinct voting terminal having data entry and voice activation software with a plurality of automated touchtone telephone devices having microphones, receivers, transmitters and receivers, and entry keypads via a secure virtual private network,
b. registering voters in accordance with election laws with a voter registration number and their name and inputting a database which stores information on each voter in a remote central receiving and processing terminal wherein voter transactions are entered and recorded,
c. creating an audio ballot suitable for transmission over a telephone, and inputting a database which stores the audio ballot and instructions required in each respective precinct computer terminal,
d. forming a secure communication link between the precinct voting computer terminal and the central receiving and processing terminal to transmit voting transaction election results,
e. assigning voters a voter access number to use with their voter registration number,
f. qualifying and allowing voters to vote on the voter touchtone telephones after they enter their registration number and voter access number,
g. talking the voter through the ballot and recording each voter's keypad or audio responses made on the touchtone telephone in the precinct voting terminal database,
h. printing two receipts listing voter choices, one for the voter and the other deposited into a locked drop box for audits and physical recounts, if necessary,
i. computer tabulating all voter's choices in response to the audio ballot in the precinct voting terminal, and
j. transmitting the tabulated voter choices to the remote central receiving and processing terminal for certification.

2. A voting method according to claim 1, including hand tabulating the votes of hearing impaired voters, and inputting their votes into the precinct voting computer terminal database.

3. A voting method according to claim 1, including randomly assigning the order of the electronic ballot choices.

4. A voting method according to claim 1, including providing the voter a slip of paper that has his registration number and voter access number.

5. A voting method according to claim 1, including continually forwarding the ballot information from the precinct voting terminals data base to the remote central receiving and processing terminal.

6. A voting method according to claim 1, including summarizing the voter's choices for final review by the voter before the electronic ballot is included in the precinct voting computer terminal database.

7. A voting method according to claim 1, including cross checking the precinct voter data base by the remote central receiving and processing terminal to find any incorrect information such as duplicates in the system, incorrect voter information, change of address, or name.

8. A voting method according to claim 1, including sending registered voters an information post card with a toll free number to enable them to call and check their voter information and obtain information about up coming elections.

9. A voting apparatus comprising:
a. at least one precinct voting computer terminal having data entry and voice activation software,
b. a plurality of automated touchtone telephone devices having microphones, receivers, transmitters and receivers, and entry keypads with compatible voter software connected to the precinct voting terminal via a virtual private network,
c. a remote central receiving and processing terminal in communication with the precinct voting terminals,
d. election voting qualification software inputted into the remote central receiving and processing terminal, which screens registering voters in accordance with election laws, and generates voter registration numbers, voter access numbers, and name lists,
e. a database inputted into the remote receiving and processing terminal containing registration number and name list information on each voter in each respective precinct,
f. audio ballot questionnaire and voter tabulation software inputted into the precinct voting terminals for eliciting and counting voter ballot choices entered via the automated touchtone telephone devices,
g. a database containing approved audio ballot and instructions inputted into each respective precinct voting terminal for transmission over the touchtone telephone devices to elicit voter choices,
h. voter phone input means to generate a database tabulation of voter choices generated by the voter tabulation software made after each voter enters their registration number and voter access number inputted,
i. a secure communication link between the precinct voting computer terminal and the central receiving and processing terminal to transmit the tabulated voter choices for certification,
j. a dual receipt printer providing one receipt listing a voter's choices to a voter and another receipt listing a voter's choices for deposit into a lockbox, and
k. a power source associated with the virtual private network to power the computer terminals, telephone devices, and related equipment.

10. A voting apparatus according to claim 9, wherein the precinct voting computer terminal voting tabulations include hand tabulated votes of hearing impaired voters.

11. A voting apparatus according to claim 9, wherein the precinct voting computer terminal randomly assigns the order of the electronic ballot choices.

12. A voting apparatus according to claim 9, wherein the voter is provided with a slip of paper having his registration number and voter access number.

13. A voting apparatus according to claim 9, wherein the precinct voting terminals continually forward the ballot tabulations to the remote central receiving and processing terminal.

14. A voting apparatus according to claim 9, wherein the touchtone telephones are programmed to summarize the voter's choices for final review by the voter before the electronic ballot is included in the precinct voting computer terminal database.

15. A voting apparatus according to claim 9, wherein the remote central receiving and processing terminal software cross checks the precinct voter data base to find any incorrect information such as duplicates in the system, incorrect voter information, change of address, or name.

16. A voting apparatus according to claim 9, wherein the remote central receiving and processing terminal generates and sends registered voters an information post card with a toll free number to enable them to call and check their voter information and obtain information about up coming elections.

17. A voting apparatus according to claim 9, wherein the audible voting ballot contains survey questions eliciting voter opinions concerning products and services.
